(19) United States
(12) Patent Application Publication
(10) Pub. No.: US 2009/0325587 A1
(43) Pub. Date: Dec. 31, 2009

(54) MOBILE TELEPHONE EXCHANGE SERVER

(76) Inventors: Junko Suginaka, Tokyo (JP); Kunihiko Negishi, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 12/448,426

(22) PCT Filed: Dec. 21, 2006
(86) PCT No.: PCT/JP2006/325515

§ 371 Date: Jun. 19, 2009

(51) Int. Cl. H04W 72/00; H04M 1/00

(52) U.S. Cl. 455/450; 455/555

(57) ABSTRACT

A mobile telephone exchange server is provided that comprises a telephone information memory corresponding to each mobile telephone and enables a plurality of mobile telephones, to which the same telephone number is allocated, to be switched to use by setting of a control flag or a busy flag with reference to memory contents of a mobile telephone ID number memory, a telephone number memory, and a telephone name memory included in each telephone information memory or by performing a simple operation while viewing a display screen of an ordinary mobile telephone, or by performing an ordinary call request operation or incoming call operation.

### TECHNICAL FIELD

The present invention relates to a mobile telephone exchange server that enables a plurality of mobile telephones to be used with the same telephone number.

### BACKGROUND ART

There is a need for switching to use a plurality of mobile telephones according to purpose.

In a known art that answers the needs, a so-called SIM (subscriber identity module) card (or a UIM (user identity module) card), which is an IC (integrated circuit) card, is inserted in a mobile telephone and this card is inserted and removed as necessary to use a plurality of mobile telephones according to purpose.

An SIM card is provided with a unique number called an IMSI (international mobile subscriber identity) and because this is memorized in association with a telephone number, a plurality of mobile telephones can be used with the same telephone number by inserting and removing the SIM card among the mobile telephones (see, for example, Patent Literature 1).

### [Patent Literature 1] JP, 2002-344620, A

### SUMMARY OF INVENTION

### Technical Problem

However, an SIM card is small, is easy to lose, breaks easily due to having a fragile structure, and is thus difficult to store or carry around safely.

Also, because a power supply of the SIM card must be turned off without fail before insertion and removal in order to protect memory data, many mobile telephones have a structure with which the SIM card cannot be inserted and removed unless a battery is removed, etc., and such operations are troublesome and inconvenient for frequent insertion and removal.

The present invention has been made in view of the above problems and an object thereof is to provide a mobile telephone exchange server that enables a plurality of mobile telephones to be switched to use with the same telephone number by a simple operation or without requiring any operation whatsoever.

### Solution to Problem

In order to achieve the above-mentioned object, a mobile telephone exchange server according to a first aspect of the present invention comprises: a telephone information database for allocating a single telephone number to a plurality of mobile telephones and memorizing control flags that indicate one of the mobile telephones to be in an operative state and the others to be in a quiescent state; an exchange function for receiving a call requested from a mobile telephone connected and furthermore making the mobile telephone receive an incoming call; and a control function for permitting a call request and an incoming call by the exchange function for the mobile telephone indicated to be in the operative state by the control flag in the telephone information database and prohibiting the call request and the incoming call by the exchange function for the mobile telephone indicated to be in the quiescent state by the control flag.

The mobile telephone exchange server according to a second aspect of the present invention further comprises: a telephone selection screen data memory for memorizing a telephone selection screen for selecting one of the mobile telephones to which the single telephone number is allocated, wherein the control function reads mobile telephone selection screen data from the telephone selection screen data memory in accordance with a request from a mobile telephone and transmits the data to the mobile telephone, makes the control flag, corresponding to a single mobile telephone designated by the mobile telephone, indicate the operative state, and makes the control flags, corresponding to all other mobile telephones with the same telephone number as the mobile telephone, indicate the quiescent state.

Moreover, in a mobile telephone exchange server according to a third aspect of the present invention, in response to a call request from a mobile telephone, the control function makes the control flag corresponding to the mobile telephone indicate the operative state and makes the control flags, corresponding to all other mobile telephones with the same telephone number as the mobile telephone, indicate the quiescent state.

Moreover, in a mobile telephone exchange server according to a fourth aspect of the present invention, when an incoming call request for the single telephone number allocated to the plurality of mobile telephones is received, the exchange function calls all of the mobile telephones with the telephone number, and the control function makes the control flag, corresponding to a mobile telephone responding first to the call, indicate the operative state and makes the control flags, corresponding to all other mobile telephones with the same telephone number as the mobile telephone, indicate the quiescent state.

### ADVANTAGEOUS EFFECTS OF INVENTION

With the mobile telephone exchange server according to the first aspect of the present invention, the plurality of mobile telephones, to which the same telephone number is allocated, can be switched to use without having to perform troublesome operations to insert and remove an SIM card that is small, is easy to lose, breaks easily due to having a fragile structure, and is thus difficult to store or carry around safely.

With the mobile telephone exchange server according to the second aspect of the present invention, a single mobile telephone of choice can be selected and switched to use from among the mobile telephones, to which the same telephone number is allocated, by a simple operation of selecting while viewing a display screen of a mobile telephone.

With the mobile telephone exchange server according to the third aspect of the present invention, by performing an ordinary calling operation, switching use can be performed automatically without requiring any special operation.

With the mobile telephone exchange server according to the fourth aspect of the present invention, by performing an ordinary incoming call operation in response to an incoming call bell tone, switching use among the mobile telephones, to which the same telephone number is allocated, can be performed automatically without requiring any special operation.

### BRIEF DESCRIPTION OF DRAWINGS

FIG. 1 is a block diagram of a mobile telephone exchange server according to the present invention.

FIG. 2 is a block diagram of a telephone information database.

FIG. 3 is a control flag setting flowchart.

FIG. 4 is a diagram of an example of a telephone selection screen.

### REFERENCE SIGNS LIST

1 mobile telephone exchange server
11 control function
12 exchange function
13 telephone information database
14 telephone selection screen data memory

### DESCRIPTION OF EMBODIMENTS

A best mode for carrying out the present invention shall now be described in detail with reference to the attached drawings.

### Example 1

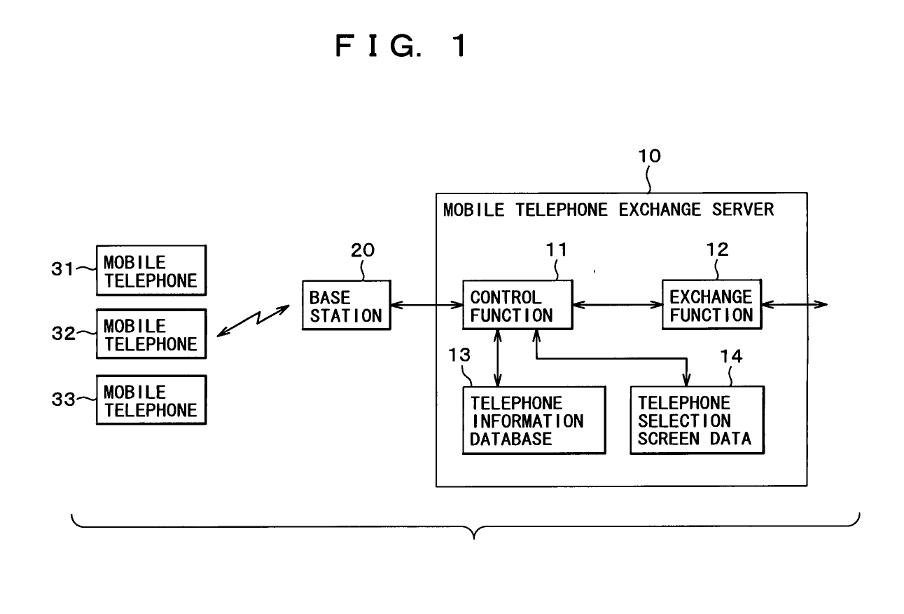

FIG. 1 is a block diagram of a mobile telephone exchange server 1 according to an example of the present invention. The mobile telephone exchange server 1 according to the present example comprises a control function 11, an exchange function 12, a telephone information database 13, and a telephone selection screen data memory 14. The mobile telephone exchange server 1 is connected to a public telephone network by the exchange function 12, and the control function 11 communicates with a plurality of mobile telephones 31 to 33 via a base station 2 and performs control for connecting a public line to the mobile telephones 31 to 33. Although of the above, the base station 2 and the mobile telephones 31 to 33 are an ordinary base station and ordinary mobile telephones and not parts of the present invention, these are shown in the figure to facilitate description of the example of the present invention.

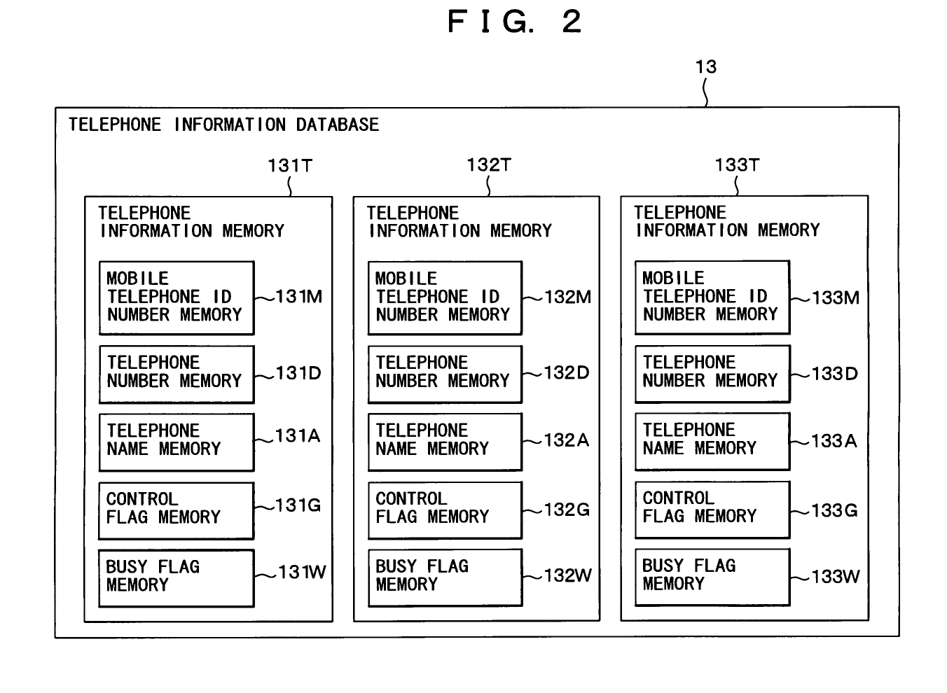

Operations of the mobile telephone server 1 shall now be described in detail using FIGS. 2 to 4.

FIG. 2 is a block diagram that schematically shows a configuration of the telephone information database 13 included in the mobile telephone exchange server 1, and telephone information data, respectively corresponding to the mobile telephones 31, 31, and 33, are accumulated in telephone information memories 131T, 132T, and 133T.

The telephone information memory 131T comprises a mobile telephone ID number memory 131M, memorizing a mobile telephone ID number unique to the mobile telephone 31, a telephone number memory 131D, memorizing a telephone number allocated to a mobile telephone user, a telephone name memory 131A, memorizing a model name or other telephone name of the mobile telephone 31, a control flag memory 131G, memorizing a control flag indicating whether the mobile telephone 31 is in an operative state or in a quiescent state, and a busy flag memory 131W, memorizing a busy flag indicating whether the mobile telephone 31 is in a calling state or a non-calling state. The telephone information memories 132T and 133T are configured in likewise manner as shown in FIG. 2.

Although the mobile telephones 31, 32, and 33 can communicate with the mobile telephone exchange server 1 via the base station 2 as necessary, connection to the public line is permitted only when the memory content of the corresponding control flag memory 131G, 132G, or 133G indicates the operative state, and when the quiescent state is indicated, connection of the corresponding telephone to the public line is prohibited.

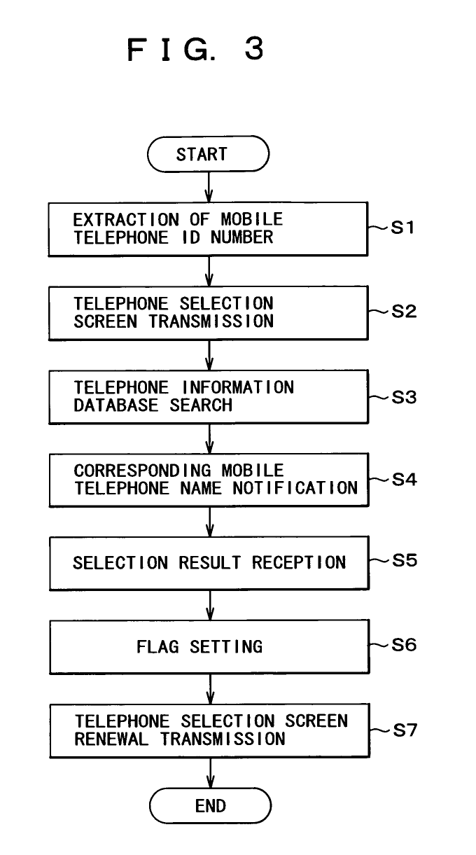

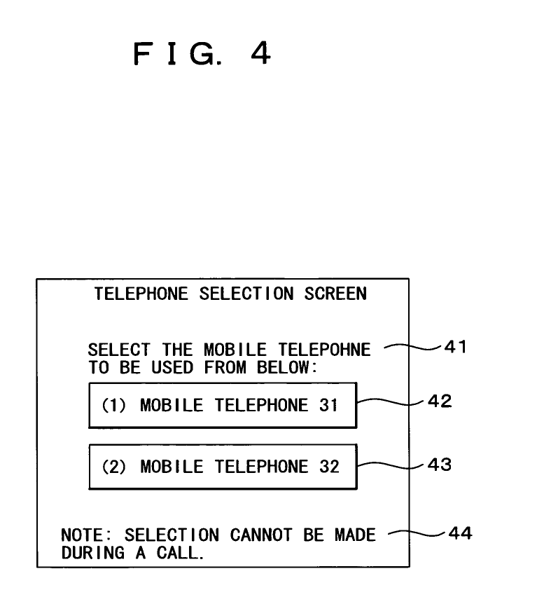

FIG. 3 is a flowchart for describing a control flag setting procedure of the control function 11, and FIG. 4 is a diagram of an example of a telephone selection screen that is displayed on a display screen of each of mobile telephones 31 to 33. In the following, the procedure of the control flag setting flowchart of FIG. 3 shall be described for an example where the same telephone number Y is allocated to the mobile telephone 31 and the mobile telephone 32 and a different telephone number Z is allocated to the mobile telephone 33.

Here, it shall be assumed that the memory content of the control flag memory 131G indicates the operative state, and the memory content of the control flag memory 132G indicates the quiescent state. In this case, whereas the mobile telephone 31 can make a call to and receive a call from the public line, the mobile telephone 32 is prohibited from making a call to and receiving a call from the public line. That is, the mobile telephone user can perform calling using the mobile telephone 31 but cannot perform calling using the mobile telephone 32.

If the user wishes to switch to and perform calling with the mobile telephone 32, the user uses an internet browsing function of the mobile telephone 31 to call the mobile telephone exchange server 1 and start the procedure. The control function 11 extracts the memory content of the mobile telephone ID number memory 131M that is included in communication contents from the calling mobile telephone 31 in a mobile telephone ID number extraction step S1 and transmits telephone selection screen data to the mobile telephone 31 in a telephone selection screen transmission step S2. Consequently, an explanation text 41, shown in FIG. 4, is displayed on the display screen of the mobile telephone 31 and the user can thereby know that the procedure has started.

In a telephone information database search step S3, the contents of the telephone information database 13 are searched, and by matching of the content extracted in advance and the memory content in the mobile telephone ID number memory 131M in the telephone information memory 131T, it is detected that the present communication is that from the mobile telephone 31 and it is detected from the memory content of the telephone number memory 131D that the telephone number Y is allocated to the mobile telephone 31. The control function 11 then searches the memory contents of all telephone number memories 132D and 133D and detects that only the telephone number memory 132D has the telephone number Y, detected in the above, as the memory content. By the above procedure, it is detected that the corresponding telephones having the same number as the mobile telephone 31 are just the two units of the mobile telephone 31 itself and the mobile telephone 32.

In the corresponding mobile telephone name notification step S4, the memory contents of the telephone name memories 131A and 132A and the memory contents of the control flag memories 131G and 132G of the telephone information memories 131T and 132T of all telephones having the same telephone number detected in the above procedure are displayed, via the internet browsing function, on the display screen of the mobile telephone 31 as shown for example in FIG. 4. Consequently, the names of all corresponding telephones, to which the same telephone number is provided, are displayed in the display screen of the mobile telephone 31. In the example of FIG. 4, the two units of (1) the mobile telephone 31 and (2) the mobile telephone 32 are displayed as a button 42 and a button 43, respectively. Whether each mobile telephone is in the operative state or the quiescent state can be checked by displaying the button of a mobile telephone in the operative state in a mode that differs from the button of a mobile telephone in the quiescent state in this display screen.

When the user viewing the display screen selects the button 43, indicating (2) the mobile telephone 32, by an unillustrated operation, the operation result is transmitted to the control function 11 via the internet browsing function and this is recognized in a selection result reception step S5.

In a control flag setting step S6, the memory content of the control flag memory 132G of the telephone information memory 132T is switched to set from the quiescent state to the operative state based on the recognition result and the memory content of the control flag memory 131G of the telephone information memory 131T, which corresponds to all other telephone information data having the same telephone number Y, is set to the quiescent state. These setting results are reflected in the telephone selection screen data and transmitted to the mobile telephone 31 in a telephone selection screen renewal transmission step S7, and the display screen of FIG. 4 changes accordingly. As a result, the user can confirm that (2) the mobile telephone 32 has been put in the operative state in place of (1) the mobile telephone 31.

Although in the above description, a case where the telephone to be made operative is selected using the mobile telephone 31 that is in the operative state was described, the same operation may also be performed as a control communication from the mobile telephone 32 that is in the quiescent state. However, to secure calling quality and prevent erroneous operation due to complexity of the control operation of the control function 11, it is preferable for the control function 11 to prohibit this operation while the memory content of the busy flag memory 131W or 132W indicates that there is an ongoing call and for this to be displayed as a notice 44 in the telephone selection screen of FIG. 4.

Also, although the initial values of the memory contents of the telephone name memories 131A and 131B are set to the model names of the mobile telephone 31, etc., arrangements may be made to enable the user to subsequently perform an operation of changing the respective contents to nicknames of choice.

As described in detail above, with the present invention, the plurality of mobile telephones, to which the same telephone number is allocated, can be switched to use as necessary by a simple operation. With the mobile telephone 33, because the telephone number Z that differs from the telephone number Y is allocated thereto, a call request, an incoming call, and other control operations can be performed without restriction during any of the procedure steps described above.

The present invention is not restricted to the example described above.

In the above description, only one mobile telephone among the mobile telephones 31 and 32, corresponding to the one memory content among the memory contents of the control flag memories 131G and 132G that indicates the operative state, is enabled to perform a call request and an incoming call, and the other telephone is prohibited from performing a call request and an incoming call. Arrangements may be made to enable a call request from one of either the mobile telephone 31 or the mobile telephone 32 regardless of the states of the control flag memories 131G and 132G. In this case, when the control function 11 detects a call request from the mobile telephone 31 or the mobile telephone 32, the control function 11 permits the call request to the called party by the exchange function 12 regardless of whether the respective memory contents of the control flag memories 131G and 132G indicate the operative or quiescent state and, at a point at which the call is established, sets the memory contents of the control flag memories 131G and 132G according to the procedure described with the control flag setting flowchart of FIG. 3, sets the memory contents of both busy flag memories 131W and 132W to the calling state, maintains this state until the call ends, and when the call ends, sets the contents to the non-calling state. The plurality of telephones to which the same telephone number Y is allocated are thus switched to use as necessary, because the control function 11 permits performing of a call request, an incoming call, and the procedure of the control flag setting flowchart described with FIG. 3 by the corresponding mobile telephone 31 or 32 only when the memory content of the corresponding busy flag memory 131W or 132W indicates the non-calling state, and while the calling is being performed with one of either the mobile telephone 31 or 32, all other mobile telephones to which the same telephone number Y is allocated cannot perform a call request, an incoming call, and the procedure of the control flag setting flowchart described with FIG. 3.

Arrangements can be made so that when a call to the telephone number Y is received, a connection can be made and calling can be performed with just one of either the mobile telephone 31 or 32 regardless of the states of the control flag memories 131G and 132G. In this case, when the control function 11 detects an incoming call request with respect to the telephone number Y from the exchange function 12, the control function 11 searches inside the telephone information database 13 to detect the mobile telephones 31 and 32, which are all of the telephones to which the telephone number Y is allocated, and calls the mobile telephones 31 and 32, which are all of the telephones to which the telephone number Y is allocated, regardless of whether the respective memory contents of the control flag memories 131G and 132G of the telephone information memories 131T and 132T indicate the operative or quiescent state. At the point at which, in response to a bell tone, vibrator vibration, etc., the user responds to the call with one of either the mobile telephone 31 or 32, the control function 11 permits the exchange function 12 to perform an incoming call and at the point at which the call is established, sets the memory contents of the control flag memories 131G and 132G according to the procedure described with the control flag setting flowchart of FIG. 3, sets the memory contents of both busy flag memories 131W and 132W to the calling state, maintains this state until the call ends, and when the call ends, sets the contents to the non-calling state. By this arrangement, the plurality of telephones to which the same telephone number Y is allocated are switched to use as necessary, because while one of the mobile telephone 31 or 32 is in the calling state, all other mobile telephones to which the same telephone number Y is allocated cannot perform a call request, an incoming call, or the procedure of the control flag setting flowchart described with FIG. 3.

Furthermore, in the above-described cases where connection to and calling with just one of either the mobile telephone 31 or 32 is to be enabled regardless of the states of the control flag memories 131G and 132G, the control flag setting procedure of FIG. 3 can be omitted, because it is performed automatically without requiring any operation whatsoever by the user that the switching between continuing to use the same telephone and switching to use the other telephone with the same telephone number for starting a call by a call request or starting a call by an incoming call by the mobile telephone 31 or 32.

Although in the above-described example and cases, the three units of telephone information memories 131T to 133T are disposed in the telephone information database 13 and the same telephone number Y is allocated to two of these units, obviously these numbers may respectively be numbers equal to or greater than the above numbers.

All publications, patents, and patent applications cited in the present Specification are incorporated as they are as references in the present Specification.

1. A mobile telephone exchange server comprising:
a telephone information database for allocating a single telephone number to a plurality of mobile telephones and memorizing control flags that indicate one of the mobile telephones to be in an operative state and the others to be in a quiescent state;
an exchange function for receiving a call requested from a mobile telephone connected and furthermore making the mobile telephone receive an incoming call; and
a control function for permitting a call request and an incoming call by the exchange function for the mobile telephone indicated to be in the operative state by the control flag in the telephone information database and prohibiting the call request and the incoming call by the exchange function for the mobile telephone indicated to be in the quiescent state by the control flag.

2. The mobile telephone exchange server according to claim 1, further comprising a telephone selection screen data memory for memorizing a telephone selection screen for selecting one of the mobile telephones to which the single telephone number is allocated, wherein
the control function reads mobile telephone selection screen data from the telephone selection screen data memory in accordance with a request from a mobile telephone and transmits the data to the mobile telephone, makes the control flag, corresponding to a single mobile telephone designated by the mobile telephone, indicate the operative state, and makes the control flags, corresponding to all other mobile telephones with the same telephone number as the mobile telephone, indicate the quiescent state.

3. The mobile telephone exchange server according to claim 1, wherein in response to a call request from a mobile telephone, the control function makes the control flag corresponding to the mobile telephone indicate the operative state and makes the control flags, corresponding to all other mobile telephones with the same telephone number as the mobile telephone, indicate the quiescent state.

4. The mobile telephone exchange server according to claim 1 or 3, wherein when an incoming call request for the single telephone number allocated to the plurality of mobile telephones is received, the exchange function calls all of the mobile telephones with the telephone number, and the control function makes the control flag, corresponding to a mobile telephone responding first to the call, indicate the operative state and makes the control flags, corresponding to all other mobile telephones with the same telephone number as the mobile telephone, indicate the quiescent state.
